(19) United States
(12) Patent Application Publication
(10) Pub. No.: US 2026/0272101 A1
(43) Pub. Date: Sep. 17, 2026

(54) SPORTS FOOTWEAR WITH IMPROVED RECYCLABILITY

(71) Applicant: ARKEMA FRANCE, Colombes (FR)

(72) Inventors: Florent ABGRALL, Serquigny (FR); Sébastien Jun MOUGNIER, Serquigny (FR); Thomas PRENVEILLE, Serquigny (FR)

(73) Assignee: ARKEMA FRANCE, Colombes (FR)

(21) Appl. No.: 18/871,947

(22) PCT Filed: Jul. 3, 2023
(86) PCT No.: PCT/FR2023/051016

§ 371 Date: Dec. 5, 2024

(30) Foreign Application Priority Data
Jul. 4, 2022 (FR) FR2206777

(51) Int. Cl. A43B 1/00; A43B 1/14; B29B 9/10; B29B 17/00; B29B 17/04

(52) U.S. Cl. CPC A43B 1/0063; A43B 1/14; B29B 9/10; B29B 17/0036; B29B 17/0412

(57) ABSTRACT

The invention is directed principally to a single-material footwear item consisting of:
(i) 15 to 65% by weight of thermoplastic polymer selected from polyamides or copolyamides;
(ii) 35 to 85% by weight of PEBA thermoplastic elastomer; and
(iii) 0 to 15% by weight of additives.

The invention is also directed to a process for its manufacture and for its recycling, and also to the composition obtainable after recycling and to its use for the manufacture of footwear items.

### TECHNICAL FIELD

The present patent application relates to footwear items with improved recyclability, to their manufacturing process and to their recycling process, and to the compositions thus obtained and the use thereof in the manufacture of footwear items.

### PRIOR ART

Through a circular economy it is possible to limit waste generation, depletion of the planet's resources, and environmental impact. Particular attention is currently being given to producing objects by means of materials which, after recycling, will have properties sufficient to enable them to be used for high performance applications and not only for lower performance applications such as for street furniture or roads.

In the context of sustainable consumption and production patterns, the recyclability of frequently renewed items such as sports equipment and the quality of the resulting recycled products are of particular importance. However, the performance requirements are particularly high for these items.

Patent EP 3 081 109 B1 proposes, in order to facilitate their recycling, a sports footwear item whose upper and sole are made mainly or even entirely of the same thermoplastic base material. Nevertheless, it appears that difficulties remain in that the recycling product thus obtained has limitations in terms of performance because the density of the parts of the footwear item differs according to their respective function.

Patent application WO 2020/201370 A1 proposes a method for recycling such footwear items in which the item is ground and then melted. This document is focused, like the previous one, on TPU.

It is important that the products employed are stable enough to be recycled entirely safely. However, when TPUs are recycled, isocyanates—which are dangerous compounds—may be observed to form.

Moreover, the footwear items proposed do not always make it possible to obtain recycled compositions with properties sufficient to allow the use thereof as a performance polymer.

### SUMMARY OF THE INVENTION

It is an object of the invention, therefore, to propose a single-material footwear item whose composition is studied so as to make it possible to obtain, on recycling, a composition capable of being used for applications requiring high performance.

It has now been demonstrated that the exclusive combination (excluding additives) in a single-material footwear item of a polyamide fraction and of a fraction of polyether with amide blocks (PEBA) makes it possible to maintain the properties better during recycling.

Indeed, the presence of polyamides in the composition is beneficial, in particular, to the aging resistance and therefore to the life of the object and to its recycling process. For its part, the presence of PEBA, which is more flexible, contributes to improving the mechanical strength of the object throughout its life, before and after recycling.

Therefore, according to a first aspect, one subject of the invention is a single-material footwear item consisting of:
(i) 15 to 65% by weight of one or more thermoplastic polymers chosen from polyamides and copolyamides;
(ii) 35 to 85% by weight of one or more thermoplastic elastomers chosen from PEBAs; and
(iii) 0 to 15% by weight of additives.

According to a preferred embodiment, the footwear item consists of:
(i) 25 to 55% by weight of one or more thermoplastic polymers chosen from polyamides or copolyamides;
(ii) 45 to 75% by weight of one or more thermoplastic elastomers chosen from PEBAs; and
(iii) 0 to 15% by weight of additives.

According to one embodiment, component (i) comprises a polyamide or copolyamide chosen from PA 612, PA 613, PA 912, PA 1010, PA 1012, PA 6, PA 11, PA 12, PA 6/11, PA 6/12, PA 11/12, PA 6/11/12, PA 6/66/12, PA 6/1010, PA 6/1012, PA 6/1010/1012, PA 6/1012/12, PA 6/66/11/12, and PA 6/1010/1012/1014, alone or as a mixture.

According to one embodiment, component (ii) comprises a PEBA chosen from those comprising blocks of PA 6/11 and derived from PTMG, PA 6/12 and derived from PTMG, PA 11/12 and derived from PTMG, PA 6/11/12 and derived from PTMG, PA 6/66/12 and derived from PTMG, PA 6/1010 and derived from PTMG, PA 6/1012 and derived from PTMG, PA 6/1010/1012 and derived from PTMG, PA 6/1012/12 and derived from PTMG, PA 6 and derived from PTMG, PA 11 and derived from PTMG, PA 12 and derived from PTMG, PA 6 and derived from PEG, PA 11 and derived from PEG, and PA 12 and derived from PEG.

According to one embodiment, the polyamides or copolyamides of component (i) have an average ratio of the number of carbon atoms per amide function of greater than 6, preferably greater than 8 and in particular of 10 or more.

According to one embodiment, the single-material footwear item comprises, as additive, 0 to 10% by weight, preferably 0.1 to 4% by weight of adhesive.

According to one embodiment, the adhesive comprises or consists of polyurethane.

According to a second aspect, the invention is directed to a process for manufacturing such a single-material footwear item, comprising the steps of:
I. providing a material comprising one or more polyamides or copolyamides, one or more PEBAs and/or one or more additives suitable for each component of the footwear item;
II. manufacturing the components of the footwear item from the respective thermoplastic material; and
III. assembling the components of the footwear item, by means of an adhesive where appropriate, to form the finished footwear item,
   in which the materials used are chosen such that the finished footwear item comprises 15 to 65% by weight of one or more thermoplastic polymers chosen from polyamides and copolyamides; 35 to 85% by weight of one or more thermoplastic elastomers chosen from PEBAs; and 0 to 15% by weight of additives.

According to one embodiment, the materials used are chosen such that the finished footwear item comprises 25 to 55% by weight of one or more thermoplastic polymers chosen from polyamides and copolyamides; 45 to 75% by weight of one or more thermoplastic elastomers chosen from PEBAs; and 0 to 15% by weight of additives.

According to a third aspect, the invention is directed to a process for recycling such a single-material footwear item, comprising the steps of:
(a) supplying the used footwear item;
(b) grinding the clean footwear item to obtain a ground material;
(c) heating the ground material until it melts; and
(d) extruding the melt into pellets.

According to one embodiment, it further comprises the step of:
(e) adding new material to the ground used footwear item before or after step (d).

According to a fourth aspect, the invention is directed to a recycled polymer composition obtainable by said recycling process.

According to a fifth aspect, the invention is directed to a composition consisting of:
(a) 20 to 100% by weight, advantageously from 30 to 99% by weight, even more preferably from 50 to 98% by weight of pelletized ground single-material footwear items, consisting of:
   a. 15 to 65%, in particular 25 to 55% by weight of one or more thermoplastic polymers chosen from polyamides or copolyamides;
   b. 35 to 85%, in particular 45 to 75% by weight of one or more thermoplastic elastomers chosen from PEBAs; and
   c. 0% to 15% of additives;
(b) 0 to 80% by weight, preferably 1 to 70% by weight and in particular 2 to 50% by weight of virgin polymer chosen from polyamides, copolyamides and PEBAs; and
(c) 0 to 50% by weight of additives.

According to a final aspect, the invention is directed to the use of said composition resulting from the recycling process for the manufacture of footwear items, especially single-material footwear items.

### DESCRIPTION OF THE EMBODIMENTS

### Definition of the Terms

The term “polymer blend” is intended to denote a macroscopically homogeneous polymer composition. The term also encompasses such compositions composed of mutually immiscible phases dispersed at the micrometric scale.

The term “copolymer” is understood to denote a polymer resulting from the copolymerization of at least two chemically different types of monomer, referred to as comonomers. A copolymer is thus formed of at least two repeat units. It may also be formed from three or more repeating units. More specifically, the term “sequential copolymer” or “block copolymer” is understood to denote copolymers in the abovementioned sense in which at least two distinct monomer blocks are linked by covalent bonding. The length of the blocks may be variable. Preferably, the blocks are composed of 1 to 1000, preferably 1 to 100 and in particular 1 to 50 repeat units, respectively. The link between the two monomer blocks can sometimes require an intermediate nonrepeat unit known as a junction block.

The term “monomer” should be taken in the context of polyamides in the sense of “repeating unit”. Indeed, the case where a repeating unit of the polyamide consists of the combination of a diacid with a diamine is a particular case. It is considered that it is the combination of a diamine and a diacid, that is to say the diamine.diacid pair (in an equimolar amount), which corresponds to the monomer. The rationale for this is that individually the diacid or diamine is merely a structural unit, unable to polymerize on its own.

The term “single-material footwear item” is understood to mean a footwear item manufactured essentially from polymers of a given family. In the broad definition of the invention, these are thermoplastic polymers chosen from polyamides and copolymers thereof and polyethers with amide blocks (PEBAs). In principle, a single-material footwear item will not comprise other polymers, whether thermosetting polymers or polymers belonging to other families of thermoplastic polymers. On the other hand, it may comprise small quantities of agents called additives, either in the formulation of the thermoplastic polymer used for the respective parts of the item, or for specific parts of the item. An example mentioned is the presence in the single-material footwear item of an adhesive used for purposes of its assembly. Advantageously, this is a thermoplastic adhesive and in particular an adhesive in the form of a polyamide or copolyamide. Nevertheless, it is also possible to provide a non-thermoplastic adhesive, for example a polyurethane adhesive, when its presence does not exceed an amount of 10% by weight and preferably 4% by weight relative to the total weight of the footwear item.

The term “inherent viscosity” is understood to denote the viscosity as measured according to the following steps:
taking samples of polymer of between 0.07 and 0.10 g and preferably of 0.15 g maximum,
adding a sufficient amount of m-cresol solvent by weighing in order to obtain a concentration (C) of 0.5 g/L,
heating the mixture with stirring on a hotplate, regulated at 100° C.±5° C., until the polymer has completely dissolved,
cooling the solution to ambient temperature, preferably for at least 30 minutes,
measuring the flow time to of the pure solvent and the flow time t of the solution using a micro-Ubbelohde tube viscometer in a thermostatically-controlled bath regulated at 20° C.±0.05° C.,
calculating the viscosity according to the formula 1/C×Ln (t/t0), where C represents the concentration and Ln the natural logarithm.

For each sample, three measurements are taken on different solutions, then the mean is calculated.

The term “thermoplastic polymer” is understood to denote a polymer which has the property of softening when sufficiently heated and which, on cooling, becomes hard again.

The term “semicrystalline polyamide” is understood to denote a polyamide having a melting temperature (Tm) in DSC, according to the standard ISO 11357-3:2013, and an enthalpy of crystallization during the cooling step at a rate of 20 K/min in DSC, measured according to the standard ISO 11357-3 of 2013, of greater than 20 J/g, preferably greater than 30 J/g.

The term “enthalpy of fusion” is understood to denote the heat consumed during the solid/liquid transition of the thermoplastic elastomer, as measured by differential scanning calorimetry, according to the standard ISO 11257-3:1999.

The nomenclature used to denote the polyamides according to the present invention follows the standard ISO 1874-1:2010.

In what follows, the hardness is as measured according to the standard ISO 868:2003.

### The Single-Material Footwear Item

In its broadest definition, the present invention relates in particular to single-material footwear items comprising parts which consist essentially, that is to say without additives, of polymers of the polyamide, copolyamide and PEBA family. Apart from these parts, the single-material footwear item may comprise a small proportion (less than 12%, preferably less than 10% and more preferably less than 5% by weight relative to the weight of the finished single-material footwear item) of functional or decorative elements composed of different materials. Advantageously, the single-material footwear item consists essentially of polymers derived from this family.

According to one aspect, the invention is directed to a single-material footwear item consisting of:
(i) 15 to 65% by weight of one or more thermoplastic polymers chosen from polyamides and copolyamides;
(ii) 35 to 85% by weight of one or more thermoplastic elastomers chosen from PEBAs; and
(iii) 0 to 15% by weight of additives.

### The Polyamide and Copolyamide

As mentioned above, the single-material footwear item according to the invention comprises one or more polyamides or copolyamides.

In the context of this description, the term “copolyamide” is understood to denote polymers derived from the polymerization of several monomers linked by amide functions. However, copolymers comprising polyether blocks, such as PEBAs, are excluded from this definition.

According to one embodiment, the polyamide originates from the condensation of one or more monomers of α,ω-aminocarboxylic acid type or of one or more monomers of lactam type (“Z” type).

Mention may be made, by way of example of α,ω-aminocarboxylic acid, of α,ω-amino acids, such as aminocaproic acid, 7-aminoheptanoic acid, 11-aminoundecanoic acid, n-heptyl-11-aminoundecanoic acid and 12-aminododecanoic acid.

Mention may be made, by way of example of lactams, of those having from 3 to 12 carbon atoms on the main ring and which may be substituted. Mention may be made, for example, of β,β-dimethylpropiolactam, α,α-dimethylpropiolactam, amylolactam, caprolactam, capryllactam, oenantholactam, 2-pyrrolidone and lauryllactam.

Semicrystalline polyamides will most often be used for the manufacture of the single-material footwear item. Advantageously, these are aliphatic polyamides. Particularly preferred are the polyamides in which the average number of carbon atoms per amide function is greater than 6, preferably greater than 8 and most particularly 10 or more. Advantageously, they are polyamides devoid of cyclic structures, whether aromatic or cycloaliphatic.

Examples of this type of preferred polyamides include PA 6, PA 11 and PA 12 and also mixtures of these.

According to one embodiment, the polyamide originates from the condensation of a dicarboxylic acid with an aliphatic, cycloaliphatic or aromatic diamine (“XY” type, X representing the number of carbon atoms of the diamine and Y representing the number of carbon atoms of the dicarboxylic acid).

Examples of diamines include the aliphatic diamines having from 4 to 16 and preferably 6 to 12 carbon atoms, it also being possible for the diamine X to be aromatic or alicyclic. By way of examples, mention may be made of hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, polyol diamines, isophoronediamine (IPD), methylpentamethylenediamine (MPDM), bis(aminocyclohexyl)methane (BACM), bis(3-methyl-4-aminocyclohexyl)methane (BMACM), meta-xylylenediamine, trimethylhexamethylenediamine.

Examples of dicarboxylic acids include the acids Y having between 4 and 18 carbon atoms, preferably from 9 to 12 carbon atoms. Mention may be made, for example, of butanedioic acid, adipic acid, suberic acid, azelaic acid, sebacic acid, isophthalic acid, 1,4-cyclohexanedicarboxylic acid, terephthalic acid, the sodium or lithium salt of sulfoisophthalic acid, dimerized fatty acids (in particular those which have a dimer content of at least 98% and/or are hydrogenated) and 1,2-dodecanedioic acid HOOC—(CH₂)₁₀—COOH).

Examples of this type of preferred polyamides include PA 516 resulting from the condensation of pentamethylenediamine with hexadecanedioic acid, PA 612 resulting from the condensation of hexamethylenediamine and 1,12-dodecanedioic acid; PA 613 resulting from the condensation of hexamethylenediamine and brassylic acid; PA 912 resulting from the condensation of 1,9-nonanediamine and 1,12-dodecanedioic acid; PA 129 resulting from the condensation of 1,12-dodecamethylenediamine with azelaic acid; PA 1010 resulting from the condensation of 1,10-decanediamine and sebacic acid; and PA 1012 resulting from the condensation of 1,10-decanediamine and 1,12-dodecanedioic acid.

According to one embodiment, the polyamide is a copolyamide resulting from the polycondensation:
of at least two different monomers chosen from different α,ω-aminocarboxylic acids or from two different lactams or from one lactam and one α,ω-aminocarboxylic acid having different numbers of carbons; or
of at least one α,ω-aminocarboxylic acid (or a lactam), at least one diamine and at least one dicarboxylic acid, or
of an aliphatic diamine with an aliphatic dicarboxylic acid and at least one other monomer chosen from aliphatic diamines other than the preceding one and aliphatic diacids other than the preceding one.

The notation PA Z/XY, PA Z/Z′, PA Z/XY/X′Y′, PA Z/Z′/XY, PA Z/Z′/XY/X′Y′, etc., relates to copolyamides in which XY, Z, X′Y′, Z′, etc., represent XY or Z homopolyamide monomers as described above, X′Y′ being identical to or different from XY and Z′ being identical to or different from Z.

According to one embodiment, one of the monomers constituting a copolyamide may represent more than 50%, preferably more than 60%, by mass of the total monomer mixture. According to one embodiment, one of the monomers constituting a copolyamide may represent less than 90%, preferably less than 80% by mass of the total monomer mixture.

Examples of particularly preferred copolyamides are the blocks PA 6/11, PA 6/12, PA 11/12, PA 6/11/12, PA 6/66/12, PA 6/1010, PA 6/1012, PA 6/1010/1012, PA 6/1012/12, PA 6/66/11/12 and PA 6/1010/1012/1014, and also mixtures thereof.

Use may also be made of mixtures of polyamides, which may be mixtures of aliphatic polyamides and of semiaromatic polyamides and mixtures of aliphatic polyamides and of cycloaliphatic polyamides.

According to one embodiment, the single-material footwear item comprises 15 to 65%, in particular 25 to 55% by weight of one or more thermoplastic polymers chosen from polyamides and copolyamides. For example, it may comprise 15 to 20%, or 20 to 25%, or 25 to 30%, or 30 to 35%, or 35 to 40%, or 40 to 45%, or 50 to 55%, or 55 to 60%, or 60 to 65% by weight of polyamides and/or copolyamides, relative to the weight of the single-material footwear item.

Polyether with Amide Blocs (PEBA)

The single-material footwear item of the invention further comprises one or more PEBAs. According to one embodiment, the footwear item comprises parts essentially consisting of PEBA alone or mixed with one or more polyamides or copolyamides as described above.

According to one embodiment, the thermoplastic elastomer is a polyether with amide blocks (PEBA). In these copolymers, the rigid block is a polyamide comprising at least one Z- or XY-type unit:
Z being a lactam or an amino acid having 6 to 18 carbon atoms,
X being a diamine having 4 to 48 carbon atoms, and
Y being a diacid having 6 to 48 carbon atoms.

PEBAs result from the polycondensation of polyamide blocks (rigid or hard blocks) bearing reactive ends with polyether blocks (flexible or soft blocks) bearing reactive ends, such as, inter alia, the polycondensation:
1) polyamide blocks having diamine chain ends with polyoxyalkylene blocks having dicarboxylic chain ends;
2) of polyamide blocks bearing dicarboxylic chain ends with polyetherdiols (α,ω-dihydroxylated aliphatic polyoxyalkylene blocks), the products obtained being, in this particular case, polyetheresteramides.

The polyamide blocks bearing dicarboxylic chain ends originate, for example, from the condensation of polyamide precursors in the presence of a chain-limiting dicarboxylic acid.

The polyamide blocks bearing diamine chain ends originate, for example, from the condensation of polyamide precursors in the presence of a chain-limiting diamine.

Three types of polyamide blocks may advantageously be used.

According to a first type, the polyamide blocks originate from the condensation of a dicarboxylic acid, in particular those containing from 4 to 36 carbon atoms, preferably those containing from 4 to 20 carbon atoms, more preferentially from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, glutaric acid, adipic acid, suberic acid, azelaic acid, sebacic acid, dodecanedicarboxylic acid, brassylic acid, hexadecanedioic acid and octadecanedioic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 412, PA 414, PA 418, PA 516, PA 610, PA 612, PA 613, PA 614, PA 618, PA 912, PA 1010, PA 1012, PA 1014, PA 1018 and PA 129 are used. In the PA XY notation, X represents the number of carbon atoms resulting from the diamine residues and Y represents the number of carbon atoms resulting from the diacid residues, in a conventional way.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 18 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 10-aminodecanoic acid, 11-aminoundecanoic acid and 12-aminododecanoic acid.

Advantageously, the polyamide blocks of the second type are PA 10 (polydecanamide), PA 11 (polyundecanamide), PA 12 (polydodecanamide) or PA 6 (polycaprolactam) blocks. In the notation PA X, X represents the number of carbon atoms derived from amino acid residues.

According to a third type, the polyamide blocks result from the condensation of at least one α,ω-aminocarboxylic acid or lactam with at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y),
said comonomer or comonomers {Z} preferably being introduced in a weight proportion ranging advantageously up to 50%, preferably up to 20%, even more advantageously up to 10% relative to the entirety of the polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or of at least two lactams containing from 6 to 12 carbon atoms or of one lactam and one aminocarboxylic acid not having the same number of carbon atoms, in the optional presence of a chain limiter.

As examples of aliphatic α,ω-aminocarboxylic acids, mention may be made of aminocaproic acid, 7-aminoheptanoic acid, 10-aminodecanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine.

As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by Croda, or under the brand name Empol by BASF, or under the brand name Radiacid by Oleon, and polyoxyalkylene α,ω-diacids. As examples of aromatic diacids, mention may be made of terephthalic acid (T) and isophthalic acid (I).

As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 66/6, in which 66 denotes hexamethylenediamine units condensed with adipic acid and 6 denotes units resulting from the condensation of caprolactam;
PA 66/610/11/12, where 66 denotes hexamethylenediamine condensed with adipic acid, 610 denotes hexamethylenediamine condensed with sebacic acid, 11 denotes units resulting from the condensation of aminoundecanoic acid and 12 denotes units resulting from the condensation of lauryllactam.

The notations PA X/Y, PA X/Y/Z, etc. relate to copolyamides in which X, Y, Z, etc. represent homopolyamide units as described above.

Advantageously, the polyamide blocks of the copolymer used in the invention comprise polyamide blocks PA 6, PA 10, PA 11, PA 12, PA 54, PA 59, PA 510, PA 512, PA 513, PA 514, PA 516, PA 518, PA 536, PA 64, PA 66, PA 69, PA 610, PA 612, PA 613, PA 614, PA 616, PA 618, PA 636, PA 104, PA 109, PA 1010, PA 1012, PA 1013, PA 1014, PA 1016, PA 1018, PA 1036, PA 10T, PA 124, PA 129, PA 1210, PA 1212, PA 1213, PA 1214, PA 1216, PA 1218, PA 1236, PA 12T, PA 6/11, PA 6/12, PA 11/12, PA 6/11/12, PA 6/66/12, PA 6/1010, PA 6/1012, PA 6/1010/1012 or PA 6/1012/12, or mixtures or copolymers thereof; and preferably comprise polyamide blocks PA 6, PA 10, PA 11, PA 12, PA 610, PA 612, PA 1010, PA 1012 or PA 11/12, or mixtures or copolymers thereof, more preferentially polyamide blocks PA 11, PA 12, PA 11/12 PA 6 or PA 612, or mixtures or copolymers thereof.

The polyether blocks comprise essentially or consist of alkylene oxide units.

The polyether blocks can in particular be PEG (polyethylene glycol) blocks, that is to say blocks consisting of ethylene oxide units, and/or PPG (propylene glycol) blocks, that is to say blocks consisting of propylene oxide units, and/or PO3G (polytrimethylene glycol) blocks, that is to say blocks consisting of polytrimethylene glycol ether units, and/or PTMG blocks, that is to say blocks consisting of tetramethylene glycol, also called polytetrahydrofuran, units. The PEBA copolymers may comprise in their chain several types of polyethers, the copolyethers possibly being in block or statistical form.

Use may also be made of blocks obtained by oxyethylation of bisphenols, for instance bisphenol A. The latter products are notably described in EP 613 919.

The polyether blocks may also consist of ethoxylated primary amines. As examples of ethoxylated primary amines, mention may be made of the products of formula:

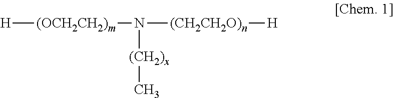

in which m and n are integers between 1 and 20 and x is an integer between 8 and 18. These products are commercially available, for example, under the brand name Noramox® from the company CECA and under the brand name Genamin® from the company Clariant.

Polyetherdiol blocks are copolycondensed with carboxy-terminated polyamide blocks. The general method for the two-step preparation of PEBA copolymers containing ester bonds between the PA blocks and the PE blocks is known and is described, for example, in FR 2846332. The general method for preparing PEBA copolymers bearing amide bonds between the PA blocks and the PE blocks is known and described, for example in EP 1482011. The polyether blocks may also be mixed with polyamide precursors and a chain-limiting diacid to prepare polymers containing polyamide blocks and polyether blocks having randomly distributed units (one-step process).

The PEBA may comprise amine chain ends, with the proviso that it comprises OH chain ends. PEBAs comprising amine chain ends may result from the polycondensation of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyetherdiols.

PEBAs are available commercially. In particular, mention may be made of the products sold by Arkema under the name Pebax®, by Evonik under the name Vestamid®, by EMS under the name Grilamid®, and by Sanyo under the name Pelestat®.

Whereas the block copolymers described above generally comprise at least one polyamide block and at least one polyether block, the PEBAs in the sense of the present description may also comprise two, three, four (or even more) different blocks chosen from those described in the present description, provided that these blocks include at least polyamide and polyether blocks.

For example, the copolymer may be a segmented block copolymer comprising three different types of blocks (or “triblock” copolymer), which results from the condensation of several of the blocks described above. Said triblock may be, for example, a copolymer comprising a polyamide block, a polyester block and a polyether block or a copolymer comprising a polyamide block and two different polyether blocks, for example a PEG block and a PTMG block. The triblock is preferably a copolyetheresteramide.

The number-average molar mass of the polyamide blocks in the PEBA copolymer is preferably from 400 to 20 000 g/mol, more preferentially from 500 to 10 000 g/mol.

The number-average molar mass of the polyether blocks is preferably from 100 to 6000 g/mol, more preferentially from 200 to 3000 g/mol.

The number-average molar mass is set by the content of chain limiter. It may be calculated according to the equation:

$${M}_{n} = {n}_{monomer} \times {MW}_{repeat unit} / {n}_{chain - limiting agent} + {MW}_{chain - limiting agent}$$

In this formula, nₘₒₙₒₘₑᵣ represents the number of moles of monomer, n_{chain limiter} represents the number of moles of diacid limiter in excess, MW_{repeating unit} represents the molar mass of the repeating unit, and MW_{chain limiter} represents the molar mass of the diacid in excess.

The number-average molar mass of the polyamide blocks and of the polyether blocks can be measured before the copolymerization of the blocks by gel permeation chromatography (GPC).

Advantageously, the mass ratio of the polyamide blocks relative to the polyether blocks of the copolymer is from 0.1 to 20, preferably from 0.5 to 18, even more preferentially from 0.6 to 15. This mass ratio may be calculated by dividing the number-average molar mass of the polyamide blocks by the number-average molar mass of the polyether blocks. Advantageously, the polyamide block-polyether block copolymer has a Shore D hardness of between 10D and 70D, preferably between 25D and 45D.

Advantageously, the PEBA has an OH function concentration of from 0.002 meq/g to 0.2 meq/g, preferably from 0.005 meq/g to 0.1 meq/g, more preferably from 0.01 meq/g to 0.08 meq/g and/or a COOH function concentration of from 0.002 meq/g to 0.2 meq/g, preferably from 0.005 meq/g to 0.1 meq/g, more preferably from 0.01 meq/g to 0.08 meq/g.

The COOH function concentration may be determined by potentiometric analysis, and the OH function concentration may be determined by proton NMR. Measurement protocols are described in detail in the article “Synthesis and characterization of poly(copolyethers-block-polyamides)—II. Characterization and properties of multiblock copolymers”, Maréchal et al., Polymer, Volume 41, 2000, 3561-3580.

Preferably, the polyamide blocks of the PEBA are chosen from PA 11, PA 12, PA 10, PA 6, PA 610, PA 612, PA 1010, PA 1012, PA 6/11, PA 6/12, PA 11/12, PA 6/11/12, PA 6/66/12, PA 6/1010, PA 6/1012 and PA 6/1010/1012, preferably PA 11, PA 12, PA 6, PA 612 and PA 11/12. Advantageously, the polyether blocks of the PEBA are polyethylene glycol and/or polytetrahydrofuran blocks.

According to one embodiment, the PEBA copolymers comprise polyamide blocks as defined above and blocks derived from PTMG, for example: comprising blocks of PA 6/11 and derived from PTMG, PA 6/12 and derived from PTMG, PA 11/12 and derived from PTMG, PA 6/11/12 and derived from PTMG, PA 6/66/12 and derived from PTMG, PA 6/1010 and derived from PTMG, PA 6/1012 and derived from PTMG, PA 6/1010/1012 and derived from PTMG, PA 6/1012/12 and derived from PTMG, PA 6 and derived from PTMG, PA 11 and derived from PTMG, PA 12 and derived from PTMG, PA 6 and derived from PEG, PA 11 and derived from PEG, and PA 12 and derived from PEG.

PEBA copolymers that are particularly preferred in the context of the invention are copolymers including blocks from among: PA 10 and PEG; PA 10 and PTMG; PA 11 and PEG; PA 11 and PTMG; PA 12 and PEG; PA 12 and PTMG; PA 610 and PEG; PA 610 and PTMG; PA 6 and PEG; PA 6 and PTMG; PA 612 and PEG; PA 612 and PTMG.

Advantageously, the PEBA may be a recycled PEBA and/or a partially or totally biobased PEBA.

According to one embodiment, the proportion by weight of polyether blocks in the copolymer is at least 50%, with respect to the total weight of the copolymer. Preferably, the proportion by mass of polyether blocks is from 45 to 85% with respect to the total weight of the copolymer, and more preferentially from 50 to 80%, and especially from 60 to 70% with respect to the total weight of the copolymer.

The proportions by mass of blocks in the copolymer may be determined from the number-average molar masses of the blocks, which can be determined by 1H NMR.

Preferably, the polyether with amide blocks (PEBA) is a linear (noncrosslinked) copolymer.

According to one embodiment, the single-material footwear item comprises 35 to 85%, in particular 45 to 75% by weight of one or more thermoplastic polymers chosen from PEBAs. For example, it may comprise 35 to 40%, or 40 to 45%, or 45 to 50%, or 50 to 55%, or 55 to 60%, or 60 to 65%, or 70 to 75%, or 75 to 80%, or 80 to 85% by weight of PEBA, relative to the weight of the single-material footwear item.

### Additives

In order to achieve the desired properties but also for esthetic purposes, the single-material footwear item may also comprise certain additives, in some or all of the parts.

In their broadest definition, additives are compounds that do not fall within the definition of components (i) and (ii), i.e., they are neither a polyamide or copolyamide nor a PEBA.

Among the additives, mention may be made in particular of fireproofing agents, flame-retardants, anti-UV agents, antioxidants, anti-abrasion agents, light stabilizers, impact modifiers, antistatic agents, optical brighteners, nucleating agents, plasticizers, adhesion promoters, adhesives, lubricants, foaming agents and pigments.

Fillers and reinforcers may also be present as additives. Mention may be made in particular of fibrous reinforcements such as glass fibers or carbon fibers, short or continuous, and optionally coated with resin, or alternatively fibers of plant matter or mineral fibers. As a variant, it is possible to envisage nonfibrous reinforcements, for example solid glass beads, but also lightweight reinforcements such as hollow glass beads or encapsulated foaming agents.

More generally, it may be necessary to provide limited amounts of polymers other than polyamides, copolyamides or PEBA in the footwear item.

Thus the parts of the footwear item are generally assembled using an adhesive. Preferably, this is an adhesive which is a polyamide or copolyamide or alternatively a PEBA. Advantageously, it may be a copolyamide. Alternatively, the adhesive employed may also be chosen in particular from polyurethanes.

In one embodiment, the single-material footwear item may therefore comprise an additive in the form of a polymer which is not a polyamide, copolyamide or PEBA. Preferably, such an adhesive, if present, is present at a low content, for example of from 0.01% to 10%, advantageously from 0.1% to 5% by weight and very particularly from 1% to 2.5% by weight relative to the weight of the footwear item.

Overall, the single-material footwear item comprises 0 to 15% of additives, for example 0 to 2.5%, or 2.5 to 5%, or 5 to 7.5%, or 7.5 to 10%, or 10 to 12.5%, or 12.5 to 15% by weight of additives relative to the weight of the single-material footwear item.

Depending on the design used for the single-material footwear item, the item comprises parts comprising as sole polymer one or more polyamides or copolyamides and others comprising as sole polymer one or more PEBAs.

Alternatively, the single-material footwear item may also comprise some or all of the parts manufactured from a polyamide or copolyamide alloy in combination with PEBA.

Finally, it is possible for the single-material footwear item to comprise parts comprising a single polymer family and other parts manufactured with an alloy of polyamide and/or copolyamide in combination with PEBA.

### Process for Manufacturing the Single-Material Footwear Item

The single-material footwear item of the invention can be manufactured by any of the processes known in the art.

In particular, according to another aspect, the invention is directed to a process for manufacturing a single-material footwear item according to the invention, comprising the steps of:
I. providing a material comprising one or more polyamides or copolyamides, one or more PEBAs and/or one or more additives suitable for each component of the footwear item;
II. manufacturing the components of the footwear item from the respective thermoplastic material; and
III. assembling the components of the footwear item, by means of an adhesive where appropriate, to form the finished footwear item,
   in which the materials used are chosen such that the finished footwear item comprises 15 to 65% by weight of one or more thermoplastic polymers chosen from polyamides and copolyamides; 35 to 85% by weight of one or more thermoplastic elastomers chosen from PEBAs; and 0 to 15% by weight of additives.

According to one embodiment, the materials used are chosen such that the finished footwear item comprises 25 to 55% by weight of one or more thermoplastic polymers chosen from polyamides and copolyamides; 45 to 75% by weight of one or more thermoplastic elastomers chosen from PEBAs; and 0 to 15% by weight of additives.

Thus, materials based on polyamide, copolyamide or PEBA will be chosen exclusively for each part of the footwear item, in particular those forming the upper and those forming the sole. Depending on the stresses of each part, a material will be chosen consisting, apart from additives, of polyamide or copolyamide alone, of PEBA alone or alternatively of a mixture of these polymers.

According to one embodiment, a single-material footwear item according to the invention can be designed with an upper composed mainly of polyamide, laces composed of polyamide, and a sole composed mainly of PEBA.

Thus, for example, a single-material footwear item according to the invention may comprise an upper comprising a textile part made of polyamide, laces made of polyamide, and a midsole and an outsole both made of PEBA, as indicated in Table 1 below.

TABLE 1

| | | | Proportion |
|---|---|---|---|
| | | | by mass |
| | | | relative to |
| | | | footwear |
| Part of | | | item |
| the shoe | Part | Polymer | [%] |
| Upper | Textile part | Polyamide | 35 |
| | Laces | Polyamide | 5 |
| | Miscellaneous | Additives | 5 |
| | (eyelets, glue) | | |
| Sole | Midsole | PEBA | 25 |
| | Outsole | PEBA | 30 |
| Total | | | 100 |

The properties of the single-material footwear item parts can be optimized respectively by opting for certain specific grades of polyamide, copolyamide or PEBA. Moreover, it is possible to use alloys of these polymers. The weight of the respective parts can then also be modulated so that the single-material footwear item has the ratio of polyamide/copolyamide to PEBA as claimed. The single-material footwear item thus designed may make it possible to obtain a recycled composition with good properties.

### Process for Recycling the Single-Material Footwear Item

Owing to the fact that it consists essentially of thermoplastic materials, the single-material footwear item of the invention has the advantage of being easily recyclable. Moreover, the footwear items of the invention can also be recycled in complete safety, since they poses no risk of formation of isocyanates as do TPU-based footwear items.

Thus, according to another aspect, the invention is directed to a process for recycling the single-material footwear item according to the invention, comprising the steps of:
(a) supplying the used footwear item;
(b) grinding the clean footwear item to obtain a ground material;
(c) heating the ground material until it melts; and
(d) extruding the melt into pellets.

It is also possible to provide a cleaning step before or after step (b) to remove any soiling.

The ground footwear material obtained at the end of step (b) is generally in the form of shredded material. It comprises particles of variable shape and size but most often of a size of the order of several millimeters.

Depending on the intended application for the recycled product, it may be advantageous to add one or more virgin materials to the ground footwear item obtained from the used footwear item. Thus, according to one embodiment, the recycling process further comprises the step of:
(e) adding new material to the ground used footwear item before or after step (d).

The new material may in particular be one or more thermoplastic polymers chosen from polyamides and copolyamides. Alternatively or in combination, it may also be one or more thermoplastic elastomers chosen from PEBAs.

It is also possible to add specific additives, especially stabilizers, in particular chain extenders, making it possible to compensate for the aging of the material during its manufacture and prior use.

### Recycled Polymer Composition

The single-material footwear items of the invention can be recycled to manufacture materials having excellent properties. In particular, these materials have low density, good elastic return, suitable tensile modulus, and stable inherent viscosity, which makes them suitable for use in demanding applications and multiple recycling cycles.

Although the recycled material obtained has advantageous mechanical properties, the fact remains that the recycled polymer is modified relative to the virgin polymer. In particular, thermal and generally oxidative stresses during the manufacture of the footwear item, its use and its subsequent recycling affect some of its reactive functions.

The ground material and the composition resulting therefrom have particularities in that the polymers present are derived from used footwear items. During their use, the footwear items were in particular exposed to air and light, as well as to the liquid perspiration of the persons who wore them and the products of their degradation by microorganisms.

According to another aspect, the invention is directed to a recycled polymer composition obtainable by the process according to the invention.

This composition may consist in particular of:
(a) 20 to 100% by weight, advantageously from 30 to 99% by weight, even more preferably from 50 to 98% by weight of pelletized ground single-material footwear items, consisting of:
   a. 15 to 65%, in particular 25 to 55% by weight of one or more thermoplastic polymers chosen from polyamides or copolyamides;
   b. 35 to 85%, in particular 45 to 75% by weight of one or more thermoplastic elastomers chosen from PEBAs; and
   c. 0% to 15% of additives;
(b) 0 to 80% by weight, preferably 1 to 70% by weight and in particular 2 to 50% by weight of virgin polymer chosen from polyamides, copolyamides and PEBAs, preferably from polyamides; and
(c) 0 to 50%, preferably 5 to 40%, more preferably 10 to 30% and especially 15 to 25% by weight of additives.

Preferably, the virgin polymers are chosen from the preferred polyamides and copolyamides and PEBAs described above in the context of the single-material footwear item.

The optional additives of component (c) may be chosen in particular from the list of agents and compounds mentioned above relating to the additives present in the single-material footwear item. Advantageously, these additives comprise fillers and reinforcements as mentioned above.

### Use

Because of these advantageous properties, the composition resulting from the recycling of the single-material footwear item of the invention can be recycled for various uses, and in particular for performance applications.

According to one embodiment, this composition obtained from recycling can be used to remanufacture footwear parts, in particular those of a single-material footwear item, in particular a sports footwear item. This variant is particularly advantageous because it represents closed-loop recycling.

The invention will be explained in greater detail in the examples which follow.

### EXAMPLES

Unless otherwise mentioned, the percentages are expressed hereinafter by weight relative to the total weight of the composition.

The following materials were used:
Polyamide 11: Rilsan® FMNO, polyamide 11 homopolymer of inherent viscosity in solution of 1.05, marketed by Arkema.
PEBA 1: Pebax® RNew 40R53 SP01, marketed by Arkema, having a hardness of 90 Shore A, as measured after 3 s according to ISO standard 868:2003.
PEBA 2: Pebax® 2533 SD02, marketed by Arkema, having a hardness of 75 Shore A, as measured after 3 s according to ISO standard 868:2003.
PEBA 3: Pebax® RNew 72R53 SP01, marketed by Arkema, having a hardness of 72 Shore D, as measured after 3 s according to ISO standard 868:2003.
TPU 1: Elastollan® 1180A, marketed by BASF, having a hardness of 80 Shore A, as measured after 3 s according to ISO standard 868:2003.
TPU 2: Elastollan® 1164D, marketed by BASF, having a hardness of 64 Shore D, as measured after 3 s according to ISO standard 868:2003.
Antioxidant 1: Irganox® 245 marketed by BASF.
Antioxidant 2: Irgafos® 168 marketed by BASF.

### Example EI 1 to EI2

Various formulations of polyamide and PEBA, their composition indicated in Table 2 below, are prepared by compounding in a corotating twin-screw extruder at a temperature of 230° C. in order to evaluate their behavior after aging and recycling.

On leaving the extruder, the molten polymer is solidified by passing through a bath of water at 25° C. and then chopped into pellets. These are then dried for 8 h at 80° C. in an oven under reduced pressure in order to reach a residual moisture content <0.1%.

The products are then used by injection at 250° C. in the form of plates with dimensions of 100×100×2 mm. These samples are subjected to UV aging for 1000 h in a Xenon QSun enclosure to simulate their first life.

These aged samples are shredded in a model RS2402 cutter mill from the supplier Getecha. This ground material is then again melted and homogenized in a corotating twin-screw extruder at 230° C. The molten polymer is solidified by passing through a bath of water at 25° C. and then chopped into pellets of recycled product, which are then dried for 8 h under reduced pressure to achieve a humidity of less than 0.1%.

The pellets of recycled product are finally injected at 250° C. to form the test pieces necessary for the characterizations: ISO 527 1A dumbbells (tensile), bars of dimensions 80×10×4 mm (Charpy impact) and plates of dimensions 100×100×2 mm³. Before measurement, the test pieces are conditioned for 15 days in a controlled atmosphere at 23° C. and 50% relative humidity.

The test pieces manufactured are then used to evaluate the mechanical properties of the formulations after recycling as follows.

### A. Modulus and Elongation at Break Under Tensile Load

The tensile modulus and the elongation at break are measured on a Zwick dynamometer at 23° C. and 50% relative humidity according to ISO standard 527-1-2019.

### B. Impact Resistance

The energy dissipated (resilience) during a Charpy impact with a notch is measured at a temperature of −30° C. according to ISO standard 179/:1993 1 eA.

### C. Tear Resistance

The tear resistance is measured on an angular test piece with a notch, cut with a punch from a plate of 100×100×2 mm. The test is carried out on a Zwick dynamometer at 23° C., 50% relative humidity and a speed of 500 mm/min, according to ISO standard 34-1-2010.

### D. Compounds Produced in the Recycling Process

The presence of isocyanate functions (toxic) is detected by infrared FTIR spectrometry in ATR mode on diamond crystal by checking the appearance of the specific absorption band at 2270 cm⁻¹. This measurement is carried out on the pellets of recycled product one hour after their extrusion.

### Comparative Examples EC A to EC E

Formulations comprising polyamide and PEBA in different proportions and based on TPU are prepared as indicated in examples EI1 and EI2 above and the procedure is the same to age them and then to make test pieces therefrom, which are evaluated in the same way.

The composition of the formulations and the evaluation results are collated in Table 2 below.

TABLE 2
Compositions of the mixtures studied and recycling properties

| Compositions (%) | EI 1 | EI 2 | EC A | EC B | EC C | EC D | EC E |
|---|---|---|---|---|---|---|---|
| Polyamide 11 | 44.5 | 44.5 | 9.5. | 79.5 | — | — | — |
| PEBA 1 | 55 | 35 | 90 | 20 | — | 55 | — |
| PEBA 2 | — | 20 | — | — | — | — | — |
| PEBA 3 | — | — | — | — | 99.5 | 44.5 | — |
| TPU 1 | — | — | — | — | — | — | 55 |
| TPU 2 | — | — | — | — | — | — | 44.5 |
| Antioxidant 1 | 0.1 | 0.1 | 0.1 | 0.1 | 0.1 | 0.1 | 0.1 |
| Antioxidant 2 | 0.4 | 0.4 | 0.4 | 0.4 | 0.4 | 0.4 | 0.4 |
| Tensile modulus (MPa) | 580 | 490 | 100 | 940 | 560 | 150 | 130 |
| Elongation at break (%) | >100% | >100% | 82 | >100% | 83 | 78 | 67 |
| Impact resistance (kJ/m²) | 14 | 16 | 8 | 15 | 9 | 8 | 6 |
| Tear resistance (kN/m) | 118 | 109 | 47 | 163 | 81 | 68 | 55 |
| Presence of isocyanate (IR at 2270 cm⁻¹) | No | No | No | No | No | No | Yes |

The results demonstrate that examples EI 1 and EI 2, which are representative of footwear items according to the invention, still exhibit good properties after recycling, which makes them advantageous as starting material for the manufacture of performance articles such as in particular sports footwear items. The combination of polyamide and PEBA in the specific ratio of the invention makes it possible, indeed, to obtain excellent mechanical properties, both in terms of modulus and in terms of tear resistance and Charpy notched impact resistance.

Conversely, the comparative examples EC A, EC C, EC D and EC F demonstrate that compositions which do not satisfy the criteria of the invention exhibit weak properties after recycling and cannot therefore be envisaged for demanding applications. Indeed, when the footwear item comprises too much PEBA, the tensile modulus becomes insufficient, and the tear and impact resistance fall, as illustrated by examples EC A, EC C and EC D. When the footwear item comprises too much polyamide, the mixture has a very high tensile modulus, incompatible with re-use for the manufacture of footwear items, as illustrated by comparative example EC B. Finally, the recycling of TPU, beyond the low performances obtained, gives rise to the formation of isocyanates, which makes the use of this material for recyclable articles difficult from an HSE point of view.

1. A single-material footwear item consisting of:
(i) 15 to 65% by weight of one or more thermoplastic polymers chosen from polyamides and copolyamides;
(ii) 35 to 85% by weight of one or more thermoplastic elastomers chosen from PEBAs; and
(iii) 0 to 15% by weight of additives.

2. The footwear item as claimed in claim 1, consisting of:
(i) 25 to 55% by weight of one or more thermoplastic polymers chosen from polyamides or copolyamides;
(ii) 45 to 75% by weight of one or more thermoplastic elastomers chosen from PEBAs; and
(iii) 0 to 15% by weight of additives.

3. The single-material footwear item as claimed in claim 1, wherein component (i) comprises a polyamide or copolyamide chosen from PA 612, PA 613, PA 912, PA 1010, PA 1012, PA 6, PA 11, PA 12, PA 6/11, PA 6/12, PA 11/12, PA 6/11/12, PA 6/66/12, PA 6/1010, PA 6/1012, PA 6/1010/1012, PA 6/1012/12, PA 6/66/11/12, and PA 6/1010/1012/1014, alone or as a mixture.

4. The single-material footwear item as claimed in claim 1, in which component (ii) comprises a PEBA chosen from those comprising blocks of PA 6/11 and derived from PTMG, PA 6/12 and derived from PTMG, PA 11/12 and derived from PTMG, PA 6/11/12 and derived from PTMG, PA 6/66/12 and derived from PTMG, PA 6/1010 and derived from PTMG, PA 6/1012 and derived from PTMG, PA 6/1010/1012 and derived from PTMG, PA 6/1012/12 and derived from PTMG, PA 6 and derived from PTMG, PA 11 and derived from PTMG, PA 12 and derived from PTMG, PA 6 and derived from PEG, PA 11 and derived from PEG, and PA 12 and derived from PEG.

5. The single-material footwear item as claimed in claim 1, in which the polyamides or copolyamides of component (i) have an average ratio of the number of carbon atoms per amide function of greater than 6.

6. The single-material footwear item as claimed in claim 1, comprising, as additive, 0 to 10% by weight of adhesive.

7. The single-material footwear item as claimed in claim 6, wherein the adhesive comprises or consists of polyurethane.

8. A process for manufacturing a single-material footwear item as claimed in claim 1, comprising the steps of:
I. providing a material comprising one or more polyamides or copolyamides, one or more PEBAs and/or one or more additives suitable for each component of the footwear item;
II. manufacturing the components of the footwear item from the respective thermoplastic material; and
III. assembling the components of the footwear item, by means of an adhesive where appropriate, to form the finished footwear item,
in which the materials used are chosen such that the finished footwear item comprises 15 to 65% by weight of one or more thermoplastic polymers chosen from polyamides and copolyamides; 35 to 85% by weight of one or more thermoplastic elastomers chosen from PEBAs; and 0 to 15% by weight of additives.

9. The manufacturing process as claimed in claim 8, wherein the materials used are chosen such that the finished footwear item comprises 25 to 55% by weight of one or more thermoplastic polymers chosen from polyamides or copolyamides; 45 to 75% by weight of one or more thermoplastic elastomers chosen from PEBA; and 0 to 15% by weight of additives.

10. A process for recycling the single-material footwear item as claimed in claim 1, comprising the steps of:
(a) supplying the used footwear item;
(b) grinding the clean footwear item to obtain a ground material;
(c) heating the ground material until it melts; and
(d) extruding the melt into pellets.

11. The recycling process as claimed in claim 10, further comprising the step of:
(e) adding new material to the ground used footwear item before or after step (d).

12. A recycled polymer composition obtainable by the process as claimed in claim 10.

13. A composition consisting of:
(a) 20 to 100% by weight of pelletized ground single-material footwear items, consisting of:
a. 15 to 65% by weight of one or more thermoplastic polymers chosen from polyamides or copolyamides;
b. 35 to 85% by weight of one or more thermoplastic elastomers chosen from PEBAs; and
c. 0% to 15% of additives;
(b) 0 to 80% by weight of virgin polymer chosen from polyamides, copolyamides and PEBAs; and
(c) 0 to 50% by weight of additives.

14. A method using the composition as claimed in claim 12 for the manufacture of footwear items.

15. The method as claimed in claim 14, wherein the footwear items are single-material footwear items.
